(19) United States
(12) Patent Application Publication
(10) Pub. No.: US 2014/0182559 A1
(43) Pub. Date: Jul. 3, 2014

(54) Gaseous Fuel System, Direct Injection Gas Engine System, and Method

(71) Applicant: CATERPILLAR INC., Peoria, IL (US)

(72) Inventors: Joshua W. Steffen, El Paso, IL (US); Dana R. Coldren, Secor, IL (US)

(73) Assignee: Caterpillar Inc., Peoria, IL (US)

(21) Appl. No.: 13/730,118

(22) Filed: Dec. 28, 2012

(51) Int. Cl. F02M 69/04

(52) U.S. Cl. CPC F02M 69/04
USPC 123/478; 62/49.1; 62/50.6

(57) ABSTRACT

The disclosure describes an engine system having liquid and gaseous fuel systems, each of which injects fuel directly into an engine cylinder. A controller controls the pumping of a liquefied natural gas (LNG) in the gaseous fuel system using variable speeds for reciprocally moving a pumping piston of a pumping element with a drive assembly. The controller adjustably controls the drive assembly of the pump system to vary a time period for the pump cycle based upon a comparison of a pressure measured in the accumulator and a target pressure condition. When the accumulator pressure satisfies the target pressure condition, the controller is adapted to control the drive assembly such that the pumping element is in a creep mode in which the pumping piston continues to move, but produces no more than a nominal amount of compressed LNG.

### TECHNICAL FIELD

This patent disclosure relates generally to internal combustion engines and, more particularly, to a gaseous fuel system for direct injection gas engines.

### BACKGROUND

There are various different types of engines that use more than one fuel. One type is known as a direct injection gas (DIG) engine, in which a gaseous fuel, such as liquefied natural gas (LNG), is injected into the cylinder at high pressure while combustion in the cylinder from a diesel pilot is already underway. DIG engines operate on the gaseous fuel, and the diesel pilot provides ignition of the gaseous fuel. Another type of engine that uses more than one fuel is typically referred to as a dual-fuel engine, which uses a low-pressure gaseous fuel such as natural gas that is mixed at relatively low pressure with intake air admitted into the engine cylinders. Dual-fuel engines are typically configured to operate with liquid fuel such as diesel or gasoline at full power. The gaseous fuel is provided to displace a quantity of liquid fuel during steady state operation. The air/gaseous fuel mixture that is provided to the cylinder under certain operating conditions is compressed and then ignited using a spark, similar to gasoline engines, or using a compression ignition fuel, such as diesel, which is injected into the air/gaseous fuel mixture present in the cylinder.

In dual fuel engines, the gaseous fuel is stored in a pressurized state in a pressure tank, from which it exits in a gaseous state before being provided to the engine. In DIG engines, however, the gaseous fuel is stored in a liquid state at low pressure, such as atmospheric pressure, and at low, cryogenic temperatures in a liquid storage tank. When exiting the liquid storage tank, the liquefied gaseous fuel requires heating to ultimately evaporate and reach a gaseous state before or when it is provided to the engine cylinders.

Conventional cryogenic pumps (e.g., a reciprocating piston pump) employ an intermittent pump operation (i.e., a start-stop operation). The dynamic loads involved with starting and stopping a cryogenic pump, as well as the greater friction to overcome when in a static position, contribute to the breakdown of a cryogenic pump and can cause the cryogenic pump to have a shortened lifespan.

Canadian Patent Application 2523732 A1 is entitled, “System and Method for Delivering a Pressurized Gas From a Cryogenic Storage Vessel.” The '732 patent is directed to a fluid delivery system and method that pumps a process fluid from a cryogenic storage vessel and delivers it to an end user as a pressurized gas. The method in the '732 patent comprises starting a pump and pumping the process fluid and thereby pressuring it when a process fluid pressure is below a predetermined low pressure threshold, stopping the pump when the process fluid pressure is above a predetermined high pressure threshold, directing the process fluid from the pump to a vaporizer and transferring heat from a heat exchange fluid to the process fluid to convert the process fluid from a liquefied form to a gaseous phase, delivering the process fluid from the vaporizer to the end user.

It will be appreciated that this background description has been created by the inventors to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure, in one embodiment, is directed to a direct injection gas (DIG) engine system. The DIG engine system includes an engine, a liquid fuel system, and a gaseous fuel system. The engine has at least one engine cylinder that forms a variable volume between a reciprocating piston, a bore, and a flame deck. The liquid fuel system includes a liquid fuel injector adapted to inject liquid fuel into the variable volume as an ignition source. The gaseous fuel system includes a cryogenic tank, a pumping element, a drive assembly, an accumulator, a gaseous fuel injector, a pressure sensor, and a controller.

The cryogenic tank is configured to contain a supply of liquefied natural gas (LNG). The pumping element is in fluid communication with the cryogenic tank. The pumping element has a pumping chamber and a pumping piston disposed therein. The pumping piston is reciprocally movable over a pump cycle having an intake stroke and a power stroke in opposing relationship to the intake stroke. The drive assembly is adapted to reciprocally move the pumping piston over the pump cycle to draw an amount of LNG from the cryogenic tank into the pumping chamber of the pumping element during the intake stroke and to compress the amount of LNG in the pumping chamber to form compressed LNG and pump the compressed LNG out of the pumping chamber during the power stroke.

The accumulator is in fluid communication with the pumping element. The accumulator is configured to contain a supply of the compressed LNG received from the pumping element under pressure. The gaseous fuel injector is in fluid communication with the pumping element and the accumulator. The gaseous fuel injector is adapted to inject compressed LNG into the variable volume as a power source.

The pressure sensor is operably arranged with the accumulator to detect an accumulator pressure within the accumulator and to emit an accumulator pressure signal indicative of the accumulator pressure. The controller is in electrical communication with the drive assembly and the pressure sensor. The controller is adapted to adjustably control the drive assembly to vary a time period for the pump cycle based upon a comparison of the accumulator pressure and a target pressure condition.

In another aspect, the disclosure describes in one embodiment a gaseous fuel system. The gaseous fuel system includes a cryogenic tank, a pumping element, a drive assembly, an accumulator, a pressure sensor, and a controller.

The cryogenic tank is configured to contain a supply of liquefied natural gas (LNG). The pumping element is in fluid communication with the cryogenic tank. The pumping element has a pumping chamber and a pumping piston disposed therein. The pumping piston is reciprocally movable over a pump cycle having an intake stroke and a power stroke in opposing relationship to the intake stroke. The drive assembly is adapted to reciprocally move the pumping piston over the pump cycle to draw an amount of LNG from the cryogenic tank into the pumping chamber of the pumping element during the intake stroke and to compress the amount of LNG in the pumping chamber to form compressed LNG and pump the compressed LNG out of the pumping chamber during the power stroke.

The accumulator is in fluid communication with the pumping element. The accumulator is configured to contain a supply of the compressed LNG received from the pumping element under pressure. The pressure sensor is operably arranged with the accumulator to detect an accumulator pressure within the accumulator and to emit an accumulator pressure signal indicative of the accumulator pressure. The controller is in electrical communication with the drive assembly and the pressure sensor. The controller is adapted to adjustably control the drive assembly to vary a time period for the pump cycle based upon a comparison of the accumulator pressure and a target pressure condition such that the pumping piston continuously moves.

In yet another aspect, the disclosure describes in one embodiment a method for controlling a cryogenic pump system. A pumping piston of a pumping element is reciprocally moved with a drive assembly over a pump cycle. The pump cycle includes an intake stroke and a power stroke, in opposing relationship to the intake stroke, to draw an amount of LNG from a cryogenic tank into a pumping chamber of the pumping element during the intake stroke and to compress the amount of LNG in the pumping chamber to form compressed LNG and pump the compressed LNG out of the pumping chamber during the power stroke, respectively. A supply of the compressed LNG from the pumping element is stored in an accumulator under pressure. The drive assembly is adjustably controlled to vary a time period for the pump cycle based upon a comparison of a pressure measured in the accumulator and a target pressure condition.

Further and alternative aspects and features of the disclosed principles will be appreciated from the following detailed description and the accompanying drawings. As will be appreciated, the gaseous fuel systems, direct injection gas engine systems, and methods disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic and diagrammatic view of an embodiment of a direct injection gas (DIG) and liquid fuel system for an engine.

FIG. 2 is a cross-sectional view of an embodiment of a DIG engine cylinder.

FIG. 3 is a cross-sectional view of an embodiment of a DIG and direct injection liquid fuel injector.

FIG. 4 is a schematic and diagrammatic view of an embodiment of a gaseous fuel system constructed in accordance with principles of the present disclosure.

FIG. 4a is a diagrammatic view of an embodiment of a pumping element of the gaseous fuel system of FIG. 4, illustrating the pumping element at an exemplary endpoint of an intake stroke.

FIG. 4b is a diagrammatic view as in FIG. 4a, but illustrating the pumping element at an exemplary endpoint of a power stroke.

FIG. 5 is a flow chart illustrating steps of an embodiment of a method for controlling a cryogenic pump system according to principles of the present disclosure.

### DETAILED DESCRIPTION

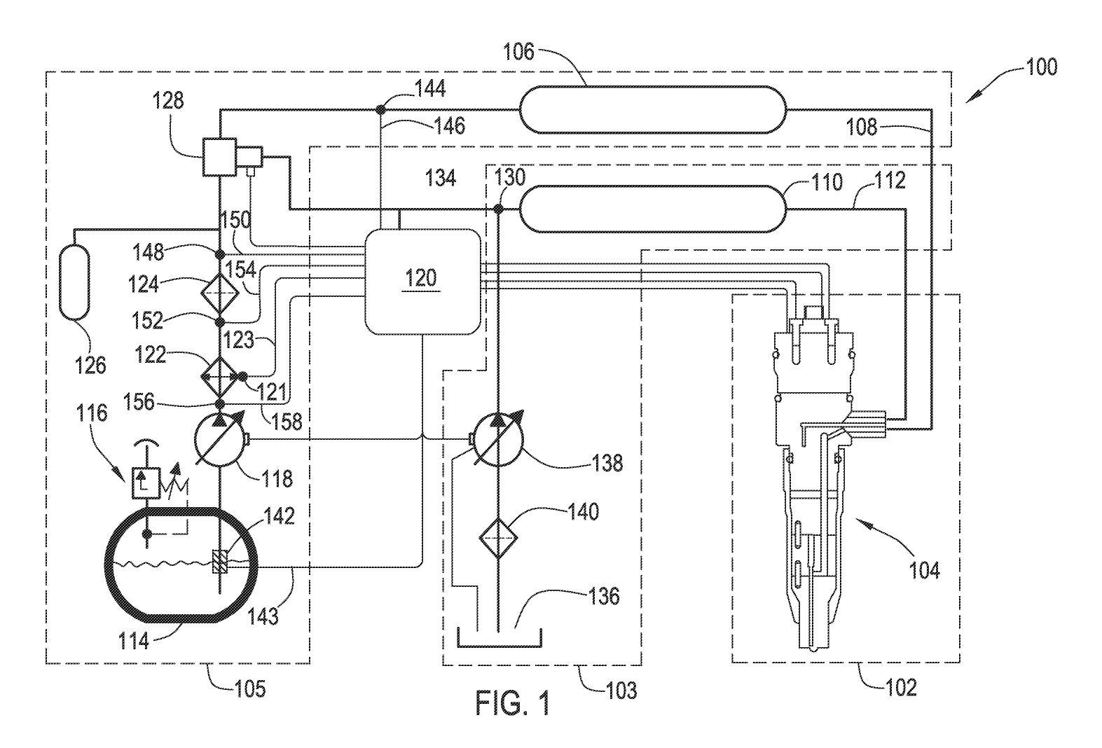

Turning now to the Figures, a block diagram of a DIG engine system 100 suitable for use with principles of the present disclosure is shown in FIG. 1. The DIG engine system 100 includes an engine 102, a liquid fuel system 103, a gaseous fuel system 105, and a controller 120.

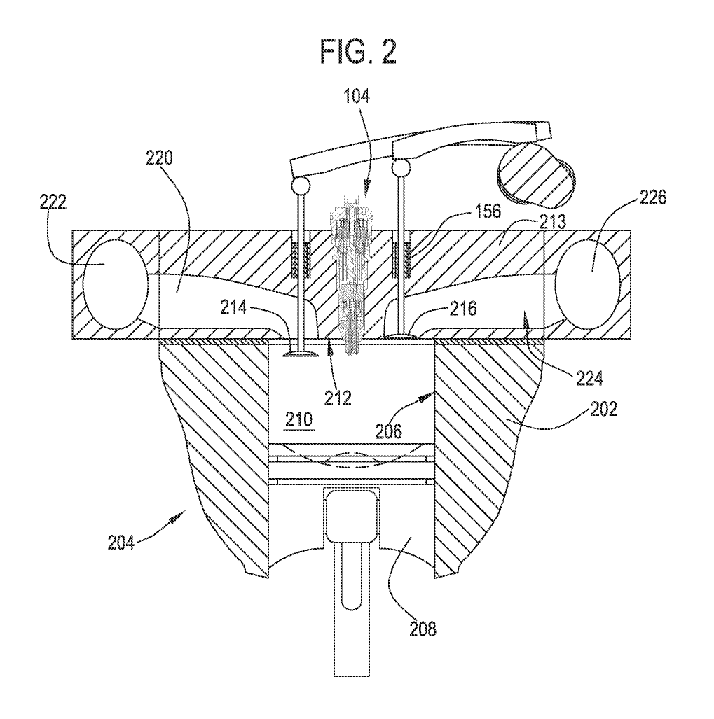

The engine 102 can have at least one engine cylinder that forms a variable volume between a reciprocating piston, a bore, and a flame deck (see FIG. 2). The DIG engine system 100 includes an engine 102 (shown diagrammatically in FIG. 1) having a fuel injector 104 associated with each engine cylinder (see FIG. 2). In embodiments, the engine 102 includes a plurality of engine cylinders each having a fuel injector 104 associated therewith. The illustrated fuel injector 104 is a dual-check injector configured to independently inject predetermined amounts of two separate fuels and acts as both a liquid fuel injector and a gaseous fuel injector.

The liquid fuel system 103 includes a liquid fuel injector in the form of the illustrated fuel injector 104 adapted to inject liquid fuel directly into the variable volume as an ignition source. The gaseous fuel system 105 includes a gaseous fuel injector in the form of the illustrated fuel injector 104 adapted to inject gaseous fuel directly into the variable volume as a power source. The controller 120 is adapted to control the functionality of the DIG engine system 100 and to monitor the health and operation of the DIG engine system 100.

The fuel injector 104 is connected to a high-pressure gaseous fuel rail 106 via a gaseous fuel supply line 108 and to a high-pressure liquid fuel rail 110 via a liquid fuel supply line 112. In the illustrated embodiment, the gaseous fuel is natural or petroleum gas that is provided through the gaseous fuel supply line 108 at a pressure of between about 25-50 MPa, and the liquid fuel is diesel, which is maintained within the liquid fuel rail 110 at about 25-50 MPa, but any other pressures or types of fuels may be used depending on the operating conditions of each engine application. It is noted that although reference is made to the fuels present in the gaseous fuel supply line 108 and the liquid fuel rail 110 using the words “gaseous” or “liquid,” these designations are not intended to limit the phase in which fuel is present in the respective fuel rail 106, 110 and are rather used solely for the sake of convenient reference. For example, the fuel provided at a controlled pressure within the gaseous fuel supply line 108, depending on the pressure at which it is maintained, may be in a liquid, gaseous or supercritical phase. Additionally, the liquid fuel can be any hydrocarbon based fuel; for example DME (Di-methyl Ether), biofuel, MDO (Marine Diesel Oil), or HFO (Heavy Fuel Oil).

Whether the DIG engine system 100 is installed in a mobile or a stationary application, each of which is contemplated, the gaseous fuel may be stored in a liquid state in a cryogenic tank 114, which can be pressurized at a relatively low pressure, for example, atmospheric, or at a higher pressure. In the illustrated embodiment, the cryogenic tank 114 is insulated to store liquefied natural gas (LNG) at a temperature of about −160° C. (−256° F.) and at a pressure that is between about 100 and 1750 kPa. In other embodiments, other storage conditions may be used. The cryogenic tank 114 can include a pressure relief valve 116.

During operation, LNG from the cryogenic tank is compressed, still in a liquid phase, by a pump 118, which raises the pressure of the LNG while maintaining the LNG in a liquid phase. The pump 118 is configured to selectively increase the pressure of the LNG to a pressure that can vary in response to a pressure command signal provided to the pump 118 from the controller 120.

The compressed LNG is heated in a heat exchanger 122. The heat exchanger 122 provides heat to the compressed LNG to reduce density and viscosity while increasing its enthalpy and temperature.

In one exemplary application, the LNG can enter the heat exchanger 122 at a temperature of about −160° C., a density of about 430 kg/m³, an enthalpy of about 70 kJ/kg, and a viscosity of about 169 μPa s as a liquid. The LNG can exit the heat exchanger at a temperature of about 50° C., a density of about 220 kg/m³, an enthalpy of about 760 kJ/kg, and a viscosity of about 28 μPa s. It should be appreciated that the values of such representative state parameters may be different depending on the particular composition of the fuel being used and the particular operating conditions present. In general, the fuel is expected to enter the heat exchanger in a cryogenic, liquid state, and exit the heat exchanger in a supercritical gas state, which is used herein to describe a state in which the fuel is gaseous but has a density that is between that of its vapor and liquid phases.

The heat exchanger 122 may be any known type of heat exchanger or heater for use with LNG. In the illustrated embodiment, the heat exchanger 122 is a jacket water heater that extracts heat from engine coolant. In other embodiments, the heat exchanger 122 may be embodied as an active heater, for example, a fuel fired or electrical heater, or as a heat exchanger using a different heat source, such as heat recovered from exhaust gases of the engine 102, a different engine belonging to the same system such as what is commonly the case in locomotives, waste heat from an industrial process, and other types of heaters or heat exchangers. In the embodiment shown in FIG. 1, which uses engine coolant as the heat source for the heat exchanger 122, a temperature sensor 121 is disposed to measure the temperature of engine coolant exiting the heat exchanger 122 and provide a temperature signal 123 to the controller 120.

Gas exiting the heat exchanger 122 is filtered at a filter 124. A portion of the filtered gas may be stored in a pressurized accumulator 126, and the remaining gas is provided to a pressure control module 128. Pressure-regulated gas is provided to the gaseous fuel supply line 108. The pressure control module 128 is responsive to a control signal from the controller 120 and/or is configured to regulate the pressure of the gas provided to the fuel injector 104. The pressure control module 128 can be a mechanical device such as a dome-loaded regulator or can alternatively be an electro-mechanically controlled device that is responsive to a command signal from the controller 120.

The liquid fuel system 103 includes a liquid fuel pump 138 configured to draw liquid fuel from a liquid fuel reservoir 136 and provide liquid fuel compressed to a rail pressure to the liquid fuel rail 110 that is fluidly connected to the liquid fuel injector in the form of the fuel injector 104. Liquid fuel, which in the illustrated embodiment comprises diesel fuel, is stored in the liquid fuel reservoir 136. From there, fuel is drawn into liquid fuel pump 138, in the form of a variable displacement pump in the illustrated embodiment, through a filter 140 and at a variable rate depending on the operating mode of the engine. The rate of fuel provided by the liquid fuel pump 138 is controlled by the variable displacement capability of the liquid fuel pump 138 in response to a command signal from the controller 120. Pressurized liquid fuel from the liquid fuel pump 138 is provided to the liquid fuel rail 110. A liquid fuel pressure sensor 130 can be provided to measure and provide a diesel pressure signal 134 indicative of the same to the controller 120.

The DIG engine system 100 may include various other sensors providing information to the controller 120 relative to the operating state and overall health of the system. Relative to the gaseous fuel system, a level indicator sensor 142 associated with the cryogenic tank 114 and disposed to measure a level of LNG present in the cryogenic tank 114. The level indicator sensor 142 provides a level signal 143 to the controller 120 that is indicative of the level of LNG that remains within the cryogenic tank 114.

The DIG engine system 100 may include various other sensors that are indicative of the state of the gaseous fuel at various locations in the system. The gas state thus indicated may be based on a direct measurement of a parameter or on a so-called “virtual” measurement of a parameter, which relative to this disclosure means a determination of a parameter that is inferred based on another directly measured parameter having a known or estimated relationship with the virtually measured parameter. As used herein, gas state is meant to describe a parameter indicative of the thermodynamic state of the gaseous fuel, for example, the pressure and/or temperature of the fuel, as appropriate. When determining the state of the gas, the parameter of interest for purpose of diagnosing the health of the system depends on changes that may occur to the state of the gas. Accordingly, while pressure of the gas may be relevant to diagnosing the operation of a pump, the temperature of the gas may be more relevant to diagnose the operating state of a heat exchanger that heats the gas. In the description that follows, reference is made to “state” sensors, which should be understood to be any type of sensor that measures one or more state parameters of the gas, including but not limited to pressure, temperature, density and the like.

Accordingly, a gas state sensor 144 is disposed to measure and provide a rail state signal 146 indicative of a fluid state at the gaseous fuel supply line 108. The rail state signal 146 may be indicative of pressure and/or temperature of the gas. A state sensor 148 is disposed to measure and provide a filter state signal 150 indicative of the gas state between (downstream of) the filter 124 and (upstream of) the pressure control module 128. The filter state signal 150 may be indicative of gas pressure. An additional state sensor 152 is disposed to measure and provide a heater state signal 154 indicative of the gas state between the heat exchanger 122 and the filter 124. The heater state signal 154 may be indicative of gas temperature at that location. An additional state sensor 156 is disposed to measure and provide a liquid state signal 158 at the outlet of the pump 118. The liquid state signal 158 at the outlet of the pump 118 may be indicative of gas pressure, for purpose of diagnosing pump operation, and/or gas temperature, for purpose of comparing to the heater state signal 154 downstream of the heat exchanger 122 for diagnosing the operating state of the heat exchanger 122. The rail state signal 146, filter state signal 150, heater state signal 154, liquid state signal 158, and/or other state signals indicative of the fluid state for the liquid/gaseous fuel are provided to the controller 120 continuously during operation.

The controller 120 includes functionality and other algorithms operating to monitor the various signals provided by system sensors and detect various failure or abnormal operating modes of the DIG engine system 100 such that mitigating actions can be taken when an abnormal operating condition is present. In other words, the controller 120 includes a failure mitigation system for the DIG engine system 100 that can detect and address fuel system failures or abnormal operating modes in the fuel system, especially abnormal operating modes in the gaseous fuel system. Examples of abnormal operating modes of the system may include depletion of the LNG in the cryogenic tank 114, malfunction of the pump 118 or its controller, clogging of any of the filters, freezing and/or clogging of the heat exchanger 122, malfunction of the pressure control module 128, and/or other malfunctions that specifically relate to the supply of the compressed gas to and from the gaseous fuel supply line 108.

During normal operation, gaseous and liquid fuel can be independently injected at high pressure into engine cylinders through the fuel injector 104. When an abnormal operating condition is present that diminishes the ability of the DIG engine system 100 (FIG. 1) to provide a sufficient amount of gaseous fuel to operate the engine, the controller 120 can be adapted to activate a limp-home mode. During the limp-home operating mode, various engine parameters are adjusted to enable engine operation on the liquid fuel under conditions that provide sufficient power to move the vehicle, into which the engine is installed, to a service location. In one embodiment, for example, the engine power while operating in limp-home mode is about 50% of total engine power such that even a fully-laden vehicle travelling up an incline will be able to maintain sufficient power to dump the load and move the vehicle to a safe location.

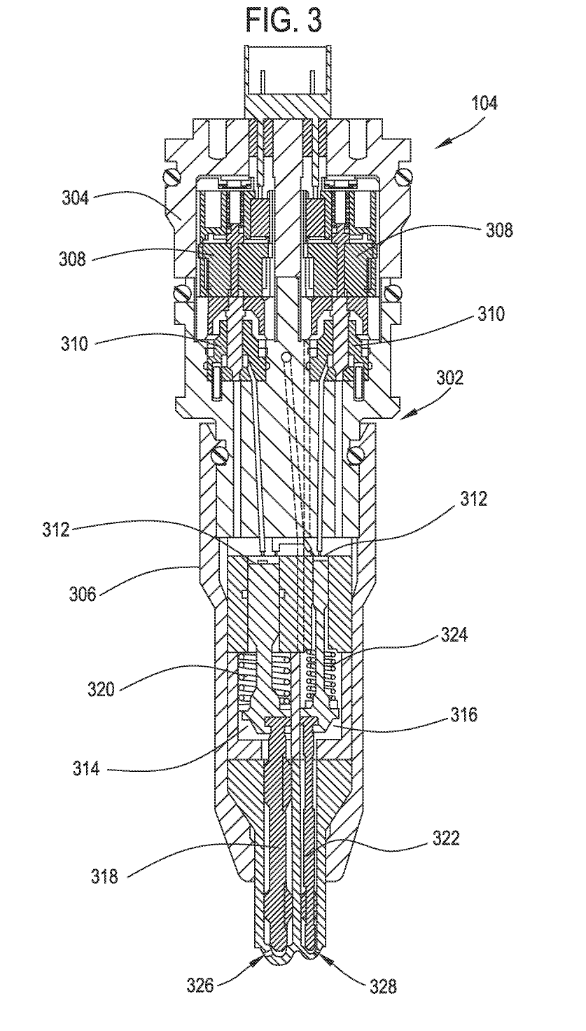

A cross section of one embodiment for the injector 104 is shown installed in an engine cylinder 204 in FIG. 2 and removed from the engine in FIG. 3. Although the injector 104 shown in these Figures has two checks arranged side by side, any other fuel injector design is suitable, for example, dual injectors having concentric checks or needle valves. In reference now to the Figures, each engine cylinder 204 includes a bore 206, which is formed within a cylinder block 202 and slidably accepts therewithin a piston 208. As is known from typical engine applications, pistons can be connected to an engine crankshaft (not shown), which operates to provide a force tending to move each piston within the cylinder bore, for example, during a compression stroke, as well as can be moved by a force applied by the piston to rotate the crankshaft, for example, during a combustion or power stroke.

The cylinder 204 defines a variable volume 210 that, in the illustrated orientation, is laterally bound by the walls of the bore 206 and is closed at its ends by a top portion or crown of the piston 208 and by a surface 212 of the cylinder head 213, which is typically referred to as the flame deck. The variable volume 210 changes between maximum and minimum capacity as the piston 208 reciprocates within the bore 206 between bottom dead center (BDC) and top dead center (TDC) positions, respectively.

In reference to FIG. 2, each cylinder 204 includes at least one intake valve 214 and at least one exhaust valve 216. It is noted that, although the cylinder 204 is illustrated in a fashion consistent with an engine operating under at least a four-stroke cycle, and thus includes cylinder intake and exhaust valves, other types of engines such as two-stroke engines are contemplated but are not specifically illustrated for brevity. In the particular engine illustrated in FIG. 2, the intake and exhaust valves 214, 216 are selectively activated to fluidly connect the variable volume 210 with sinks and sources of fluids during operation of the engine 102. Specifically, the intake valve 214 selectively blocks an intake passage 220 that fluidly interconnects the variable volume 210 with an intake manifold 222. Similarly, the exhaust valve 216 selectively blocks an exhaust passage 224 that fluidly interconnects the variable volume 210 with an exhaust manifold 226. In the illustrated embodiment, the fuel injector 104 is disposed to selectively inject diesel and compressed natural gas (CNG) fuel directly into the variable volume 210 of each engine cylinder 204.

A cross section of the injector 104 is shown in greater detail in FIG. 3. It is noted that although a single injector that is configured to independently inject two fuels is shown herein, it is contemplated that two injectors, one corresponding to each of the two fuels, may be used instead of the single injector. Alternatively, a fuel injector having concentric needles can be used. Thus, the injector 104 represents one of numerous possible embodiments of injectors configured to independently inject two types of fuel. The specific embodiment of the injector 104 uses diesel fuel pressure to activate the check valve for injecting gaseous fuel, even though both fuels may be provided to the injector at about the same pressure, which in the illustrated embodiment is between 25 and 50 MPa.

In particular reference to the cross section shown in FIG. 3, the injector 104 includes an injector body 302 that comprises an actuator housing 304 and a needle housing 306. The actuator housing 304 forms an internal cavity that houses two electronic actuators 308. Each actuator 308 activates a respective two-way valve 310, which selectively pressurizes or releases fluid pressure in a respective hydraulic closing chamber 312. The injector 104 further includes two fuel inlets, each fluidly connected to a respective injection chamber. More specifically, diesel fuel from the liquid fuel rail 110 (FIG. 1) is provided to a diesel injection chamber 314, while gaseous fuel from the gaseous fuel supply line 108 (FIG. 1) is provided to a gaseous fuel injection chamber 316. A diesel fuel needle 318 is biased by a diesel closing spring 320 and by fluid pressure at the respective hydraulic closing chamber 312 towards a closed position in which fluid present in the diesel injection chamber 314 is not permitted to exit the injector 104 and enter the variable volume 210 (FIG. 2). Similarly, a gaseous fuel needle 322 is biased by gaseous fuel closing spring 324 and by a hydraulic force that results by fluid pressure present in the respective hydraulic closing chamber 312 towards a closed position.

When diesel or gas is injected from the injector 104, fuel is injected via at least one dedicated diesel nozzle opening 326 and at least one dedicated gaseous fuel nozzle opening 328, respectively, which are opened when the respective needle 318, 322 is lifted. More specifically, when injecting diesel, a signal is provided from the controller 120 (FIG. 1) to the respective actuator 308, which activates and causes the corresponding two-way valve 310 to change position and release fluid pressure in the corresponding hydraulic closing chamber 312. When this pressure is relieved, a hydraulic pressure acting on the diesel fuel needle 318 overcomes the force of the diesel closing spring 320 and permits the diesel fuel needle 318 to lift and permit diesel to be injected into the variable volume 210 (FIG. 1) through each diesel nozzle opening 326. Similarly, a separate command signal from the controller 120 is provided to the actuator 308 corresponding to the gaseous fuel side of the injector 104. Activation of this actuator 308 causes the corresponding two-way valve 310 (on the right side of the illustration of FIG. 3) to change position and release hydraulic pressure in the hydraulic closing chamber 312 corresponding to the gaseous fuel injection chamber 316. When this pressure is relieved, a hydraulic/pneumatic pressure acting on the gaseous fuel needle 322 overcomes the force of the gaseous fuel closing spring 324 and permits the gaseous fuel needle 322 to lift and permit gas to be injected at a high pressure directly into the variable volume 210 (FIG. 1) through each dedicated gaseous nozzle openings 328 of the injector 104.

In this way, the injector 104 is configured to selectively inject diesel or gas during engine operation. In the illustrated embodiment, the total fuel energy supply of the engine during normal operation is made up by an energy contribution of about 3-10% by the diesel fuel and the remaining 90-97% of the total fuel energy supply by the gaseous fuel. The specific displacement ratio of gas with diesel may vary depending on the particular operating point of the engine. These fuels are injected at different times during engine operation. For example, diesel may be injected first while the piston 208 is moving towards the TDC position as the cylinder 204 is undergoing or is close to completing a compression stroke. When combustion of the diesel fuel in the variable volume is initiated or is about to initiate, the injector 104 causes the diesel fuel needle 318 to open such that gas at a high pressure is injected directly into the cylinder 204 and combust as it is ignited by the combusting diesel fuel.

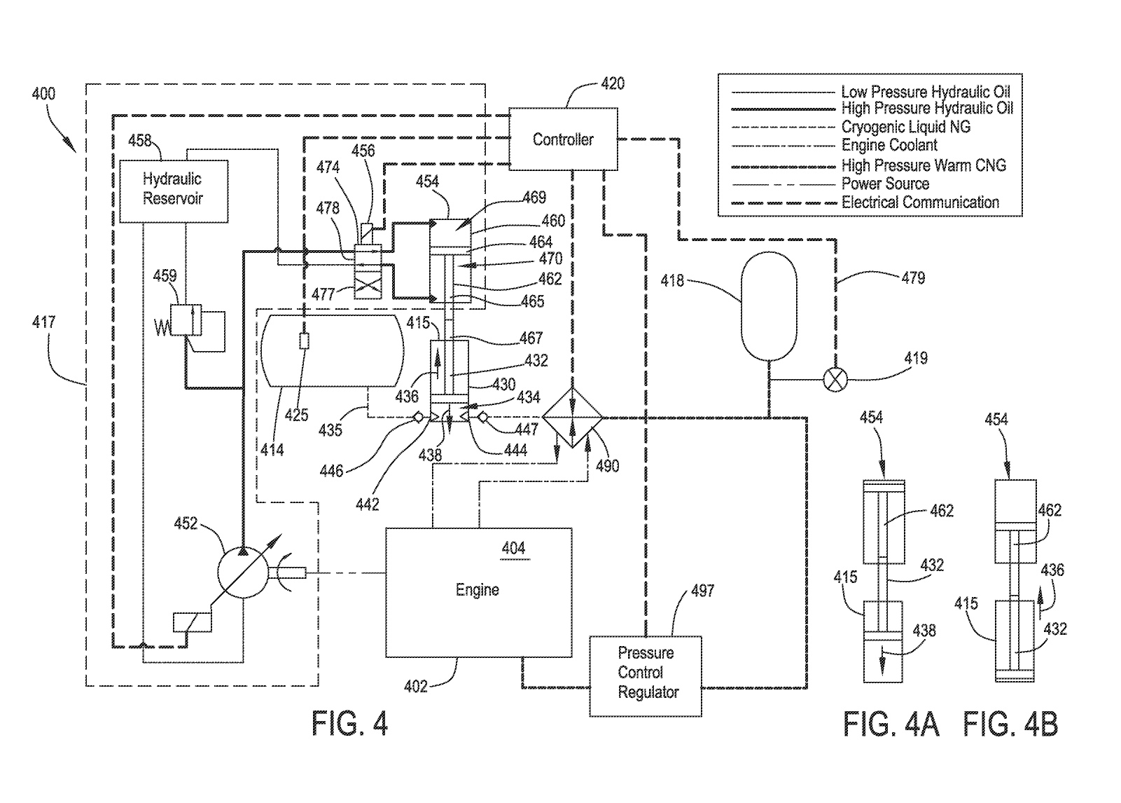

Referring to FIG. 4, an embodiment of a gaseous fuel system 400 constructed in accordance with principles of the present disclosure is shown. The gaseous fuel system 400 of FIG. 4 can be used in a DIG engine system, such as the DIG engine system 100 of FIG. 1. The gaseous fuel system 400 includes a cryogenic tank 414, a pumping element 415, a drive assembly 417, an accumulator 418, a pressure sensor 419, a gaseous fuel injector 404, and a controller 420.

The cryogenic tank 414 is configured to contain a supply of liquefied natural gas (LNG). In the illustrated embodiment, the cryogenic tank 414 is configured such that it is insulated to store LNG at a temperature of about −160° C. (−256° F.) and at a pressure that is between about 100 and 1750 kPa. In other embodiments, other storage conditions may be used. In embodiments, the cryogenic tank 414 can include a pressure relief valve.

A sensor 425 is disposed in the cryogenic tank 414. The sensor 425 is in electrical communication with the controller 420. The sensor 425 is adapted to detect an amount of LNG in the cryogenic tank 414 and to provide a level signal indicative of the amount of LNG in the cryogenic tank 414 to the controller 420. The illustrated sensor 425 comprises a fluid level sensor. In other embodiments, other suitable sensors (e.g., a weight sensor) adapted to measure a parameter suitable for use in determining the amount of LNG in the cryogenic tank 414 can be used.

The pumping element 415 is in fluid communication with the cryogenic tank 414, the accumulator 418, and the gaseous fuel injector 404. The pumping element 415 includes a body 430 and a pumping piston 432 disposed within the body 430. The pumping piston 432 and the body 430 define a pumping chamber 434 therebetween with a variable volume. In embodiments, the pumping element 415 can be disposed within the cryogenic tank 414 such that it is submersed within the supply of LNG in the cryogenic tank 414 or in fluid communication with the cryogenic tank 414 via an LNG supply line 435 as shown in FIG. 4.

The pumping piston 432 is reciprocally movable over a pump cycle having an intake stroke and a power stroke in opposing relationship to the intake stroke. The pumping piston 432 is reciprocally movable over a range of travel in an intake direction 436 and a power direction 438 in opposing relationship thereto. The pumping chamber 434 has an increasing volume when the pumping piston 432 moves in the intake direction 436. The pumping chamber 434 has a decreasing volume when the pumping piston 432 moves in the power direction 438.

The body 430 of the pumping element 415 includes an inlet 442 in fluid communication with the cryogenic tank 414 and an outlet 444 in fluid communication with the gaseous fuel injector 404. A check valve 446 can be provided at the inlet 442 of the body 430 that is configured to prevent fluid from flowing from the inlet 442 to the cryogenic tank 414 but to allow fluid to flow from the cryogenic tank 414 to the inlet 442. A check valve 447 can be provided at the outlet 444 of the body 430 that is configured to prevent fluid from flowing from gaseous fuel injector 404 to the outlet 444 but to allow fluid to flow from the outlet 444 to the gaseous fuel injector 404.

The drive assembly 417 is adapted to reciprocally move the pumping piston 432 in the pump cycle to draw an amount of LNG from the cryogenic tank 414 through the inlet 442 into the pumping chamber 434 of the pumping element 415 during the intake stroke and to compress the amount of LNG in the pumping chamber 434 to form compressed LNG and pump the compressed LNG out of the outlet 444 of the pumping chamber 434 during the power stroke. FIGS. 4a and 4b show the pumping piston 432 at an exemplary endpoint of an intake stroke and a power stroke, respectively. In the intake stroke, the pumping piston 432 moves from the endpoint of the power stroke in the intake direction 436 over the intake stroke such that the pumping piston 432 produces a negative pressure that draws LNG from the cryogenic tank 414 into the pumping chamber 434 of the body 430. In the power stroke, the pumping piston 432 moves from the endpoint of the intake stroke in the power direction 438 over the power stroke such that the pumping piston pumps compressed LNG out of the pumping chamber 434 toward the gaseous fuel injector 404.

The illustrated drive assembly 417 includes an electro-hydraulic circuit having a hydraulic pump 452, a hydraulic actuator 454, a directional control valve 456, a hydraulic reservoir 458, and the controller 420. The hydraulic pump 452 is in electrical communication with the controller 420. The hydraulic pump 452 can be adapted to provide a source of pressurized hydraulic fluid with a variable flow. A pressure relief valve 459 can be interposed between the hydraulic pump 452 and the directional control valve 456 to divert the source of pressurized hydraulic fluid to the hydraulic reservoir in the event that the pressure exceeds a predetermined threshold.

The illustrated hydraulic pump 452 comprises a variable displacement pump. The engine 402 is used to drive the hydraulic pump 452 using conventional techniques.

In other embodiments, other suitable arrangements can be used to provide a source of pressurized hydraulic fluid with a variable flow rate. For example, in embodiments, a fixed displacement pump and a variable flow control valve can be used to provide a source of pressurized hydraulic fluid with a variable flow rate to selectively drive the pumping piston 432 at different rates. In other embodiments, the hydraulic pump 452 can be driven using other power sources, such as a power-take off or a pump stack, for example.

The hydraulic actuator 454 is in selective fluid communication with the source of pressurized hydraulic fluid provided by the hydraulic pump 452 through the directional control valve 456. The hydraulic actuator 454 can be operably arranged with the pumping piston 432 of the pumping element 415 to selectively reciprocally move the pumping piston 432.

The illustrated hydraulic actuator 454 includes a cylinder 460 and a hydraulic piston 462 reciprocally movable within the cylinder 460 over a range of travel between a retracted position and an extended position (see FIGS. 4a and 4b, respectively). The hydraulic piston 462 includes a piston head 464 and a rod 465 extending from the cylinder 460. The rod 465 of the hydraulic actuator 454 can be operably arranged with the pumping piston 432 of the pumping element 415 such that moving the hydraulic piston 462 of the hydraulic actuator 454 moves the pumping piston 432 of the pumping element. In the illustrated embodiment, the rod 465 of the hydraulic actuator 454 is operably coupled with a rod 467 of the pumping piston 432. The cylinder 460 and the piston head 464 of the hydraulic piston 462 define a piston-side chamber 469 and a rod-side chamber 470 each having a variable volume.

The directional control valve 456 is in electrical communication with the controller 420. The directional control valve 456 is in fluid communication with the source of pressurized hydraulic fluid provided by the hydraulic pump 452 and in selective fluid communication with the hydraulic actuator 454. The directional control valve 456 can include a valve element 474 movable over a range of travel between an intake flow position 477 and a power flow position 478 (as shown in FIG. 4). In the intake flow position 477, pressurized hydraulic fluid flows from the hydraulic pump 452 to the hydraulic actuator 454 such that the hydraulic actuator 454 moves the pumping piston 432 of the pumping element 415 in the intake direction 436 to move over the intake stroke. In the power flow position 478 pressurized hydraulic fluid flows from the hydraulic pump 452 to the hydraulic actuator 454 such that the hydraulic actuator 454 moves the pumping piston 432 of the pumping element 415 in the power direction 438 to move over the power stroke. In other embodiments, the directional control valve 456 can include additional flow positions, such as a neutral position in which the source of pressurized hydraulic fluid is substantially prevent from flowing to the hydraulic actuator 454.

In the illustrated embodiment, the directional control valve 456 meters the source of pressurized hydraulic fluid to the piston-side chamber 469 when the valve element 474 is in the power flow position 478 to move the pumping piston 432 of the pumping element 415 in the power direction 438 over the power stroke. Hydraulic fluid in the rod-side chamber 470 can flow back through the directional control valve 456 to the hydraulic reservoir 458 for re-circulation by the hydraulic pump 452. The directional control valve 456 meters the source of pressurized hydraulic fluid to the rod-side chamber 470 when the valve element 474 is in the intake flow position 477 to move the pumping piston 432 of the pumping element 415 in the intake direction 436 over the intake stroke. Hydraulic fluid in the piston-side chamber 469 can flow back through the directional control valve 456 to the hydraulic reservoir 458 for re-circulation by the hydraulic pump 452.

The accumulator 418 is in fluid communication with the pumping element 415. The accumulator 418 can be interposed between the pumping element 415 and the gaseous fuel injector 404. The accumulator 418 is configured to contain under pressure a supply of the compressed LNG received from the pumping element 415. The pressure sensor 419 is operably arranged with the accumulator 418 to detect an accumulator pressure within the accumulator 418 and to emit an accumulator pressure signal 479 indicative of the accumulator pressure.

The controller 420 is in electrical communication with the drive assembly 417 and the pressure sensor 419. The controller 420 is adapted to adjustably control the drive assembly 417 to vary a time period for the pump cycle based upon a comparison of the accumulator pressure and a target pressure condition. In embodiments, the controller 420 is adapted to adjustably control the drive assembly 417 to continuously operate the pumping element while maintaining the accumulator pressure within a predetermined tolerance of the target pressure condition.

The illustrated controller 420 is in electrical communication with the directional control valve 456 and is adapted to selectively move the valve element 474 between the intake flow position 477 and the power flow position 478. The controller 420 can be adapted to selectively command the directional control valve 456 to direct an intake flow of pressurized hydraulic fluid to the hydraulic actuator 454 such that the hydraulic actuator 454 moves the pumping piston 432 of the pumping element 415 over the intake stroke and a power flow of pressurized hydraulic fluid to the hydraulic actuator 454 such that the hydraulic actuator 454 moves the pumping piston 432 over the power stroke.

In embodiments, the controller 420 is in electrical communication with the hydraulic pump 452 and is adapted to control the hydraulic pump 452 to vary the average flow rate of the source of pressurized hydraulic fluid to move the pumping piston 432 at different velocities. The hydraulic pump 452 is adapted to provide a source of pressurized hydraulic fluid with a variable flow for reciprocally moving the pumping piston 432. The source of pressurized hydraulic fluid can have a variable average flow rate that will proportionally drive the pumping piston 432 such that the an average pumping piston velocity changes in proportion to the change in the average flow rate of the source of pressurized hydraulic fluid.

During the intake stroke, the controller 420 is adapted to control the hydraulic pump 452 such that pressurized hydraulic fluid flows with an average intake flow rate that is proportional to the average intake velocity of the pumping piston 432 during the intake stroke when the valve element 474 is in the intake flow position. During the power stroke, the controller 420 is adapted to control the hydraulic pump 452 such that pressurized hydraulic fluid flows with an average power flow rate that is proportional to the average power velocity of the pumping piston 432 during the power stroke when the valve element is in the power flow position.

The time period for the pump cycle is a function of the average intake velocity and the average power velocity of the pumping piston 432. The faster the velocity of the pumping piston is, the shorter the time period for the pump cycle. In embodiments, the controller 420 is adapted to adjustably control the hydraulic pump 452 to vary a flow of pressurized hydraulic fluid to vary an average pumping piston velocity based upon the comparison of the accumulator pressure and the target pressure condition. In embodiments, the controller 420 is adapted to control the hydraulic pump 452 such that pressurized hydraulic fluid flows with an average flow rate that is proportional to an average velocity of the pumping piston 432 commanded by the controller. In embodiments, the controller 420 is adapted to adjustably control the drive assembly 417 to continuously operate the hydraulic pump and the pumping element while maintaining the accumulator pressure within a predetermined tolerance of the target pressure condition.

In embodiments, the controller 420 is adapted to control the hydraulic pump 452 such that pressurized hydraulic fluid flows with an average flow rate that is inversely related to the difference between the target pressure condition and the accumulator pressure. If the accumulator pressure is less than the target pressure condition, the controller 420 can be adapted to increase the average flow rate of pressurized hydraulic fluid from the hydraulic pump 452. If the accumulator pressure is greater than the target pressure condition, the controller 420 can be adapted to decrease the average flow rate of pressurized hydraulic fluid from the hydraulic pump 452.

In embodiments, the target pressure condition comprises a target pressure constant, in other words, a designated pressure value. The controller 420 can be adapted to adjustably control the drive assembly 417 to increase the time period for the pump cycle if the accumulator pressure is greater than the target pressure constant and to reduce the time period for the pump cycle if the accumulator pressure is less than the target pressure constant.

In embodiments, the controller 420 is adapted to control the drive assembly 417 such that when the accumulator pressure satisfies the target pressure condition, the controller 420 is adapted to control the drive assembly 417 such that the pumping element 415 is in a creep mode. In embodiments, the creep mode comprises a mode of operation in which the pumping element 415 delivers no more than a nominal amount of compressed LNG to the accumulator 418 within a predetermined tolerance and the time period for the pump cycle has a finite value. In embodiments, the creep mode comprises a mode of operation in which the pumping piston 432 has an average velocity greater than zero such that a frictional force imparted against the pumping piston 432 comprises kinetic friction. In embodiments, the pumping piston 432 continues to move, but produces no more than a nominal amount of compressed LNG, when in the creep mode.

In embodiments, the target pressure condition comprises a target high pressure threshold and a target low pressure threshold. The controller 420 can be adapted to control the drive assembly 417 such that the pumping element 415 is in the creep mode once the accumulator pressure is greater than the target high pressure threshold. The controller 420 can be adapted to maintain the pumping element 415 in the creep mode until the accumulator pressure is less than the target low pressure threshold.

The controller 420 can be adapted to control the drive assembly 417 such that, once the accumulator pressure falls below the target low pressure threshold, the pumping element 415 is in a charge mode. In embodiments, the charge mode comprises a mode of operation in which the pumping element 415 delivers an amount of compressed LNG sufficient to increase the accumulator pressure to the target high pressure threshold. In embodiments, the controller 420 can control the hydraulic pump 452 such that it delivers a predetermined fixed displacement of fluid to achieve a particular average flow rate when the pumping element 415 is in the charge mode.

The controller 420 can be adapted to maintain the pumping element 415 in the charge mode until the pressure sensor 419 detects that the accumulator pressure is greater than the target high pressure threshold. Once that condition is satisfied, the controller can be adapted to again control the drive assembly 417 such that the pumping element 415 is in the creep mode. Once the accumulator pressure decays below the target low pressure threshold, the controller 420 can again place the pumping element in the charge mode. The controller 420 can toggle between the creep mode and the charge mode in this way repeatedly.

The gaseous fuel system 400 further includes a heater 490 interposed between, and in fluid communication with, the pumping element 415 and the accumulator 418. In embodiments, the heater 490 is adapted to receive compressed LNG at a given temperature from the pumping element 415 and to increase the temperature of the compressed LNG to bring the compressed LNG to a supercritical gaseous state. The illustrated heater 490 is a heat exchange that uses engine coolant as the heat source. In embodiments, a filter can be interposed between the heater 490 and the accumulator 418.

The gaseous fuel system 400 can further include a pressure control module 497 interposed between, and in fluid communication with, the accumulator 418 and the gaseous fuel injector 404. The pressure control module 497 can be adapted to control a pressure of compressed LNG delivered to the gaseous fuel injector 404.

The gaseous fuel injector 404 is in fluid communication with the pumping element 415 and the accumulator 418. The gaseous fuel injector 404 is adapted to inject compressed LNG into the variable volume as a power source. Any suitable gaseous fuel injector can be used, such as those discussed herein.

The gaseous fuel system 400 can be used in embodiments of a DIG engine system, such as the DIG engine system 100 of FIG. 1. The gaseous fuel system 400 can be similar in other respects to the gaseous fuel system of FIG. 1.

### INDUSTRIAL APPLICABILITY

Embodiments of a gaseous fuel system, a DIG engine system using a gaseous fuel system and a method for controlling a cryogenic pump system are described herein. The industrial applicability of embodiments constructed according to principles of the present disclosure will be readily appreciated from the foregoing discussion. The described principles are applicable for use in multiple embodiments of an engine system and have applicability in many machines which include an engine system.

In embodiments, principles of the present disclosure are applicable to DIG engines having a gaseous fuel system operating with a liquid fuel system, which is used to provide liquid fuel that ignites the gaseous fuel. In the illustrated embodiment, both fuels are injected directly into each engine cylinder using a dual-check fuel injector. In embodiments, the hydraulic drive assembly associated with the pumping element is operated with a flow from a variable flow hydraulic pump mounted on the engine such that the cryogenic pump piston speed can be varied and reduced in cases where the engine demand is less to help avoid completely stopping the operation of the cryogenic pump system.

The pumping of the LNG can be carried out in a controlled manner to help increase pump performance and life by avoiding the dynamic loads involved with completely stopping a cryogenic pump and re-starting a cryogenic pump from a static position, including the need to overcome the greater friction from the static position. Additionally, in some embodiments, following principles of the present disclosure can allow the use of an accumulator with a relatively smaller volume.

In embodiments, a controller controls the pumping of a liquefied natural gas (LNG) in the gaseous fuel system using variable speeds for reciprocally moving a pumping piston of a pumping element by adjustably controlling a drive assembly. The controller adjustably controls the drive assembly of the pump system to vary a time period for the pump cycle based upon a comparison of a pressure measured in the accumulator and a target pressure condition. When the accumulator pressure satisfies the target pressure condition, the controller is adapted to control the drive assembly such that the pumping element is in a creep mode in which the pumping piston continues to move, but produces no more than a nominal amount of compressed LNG.

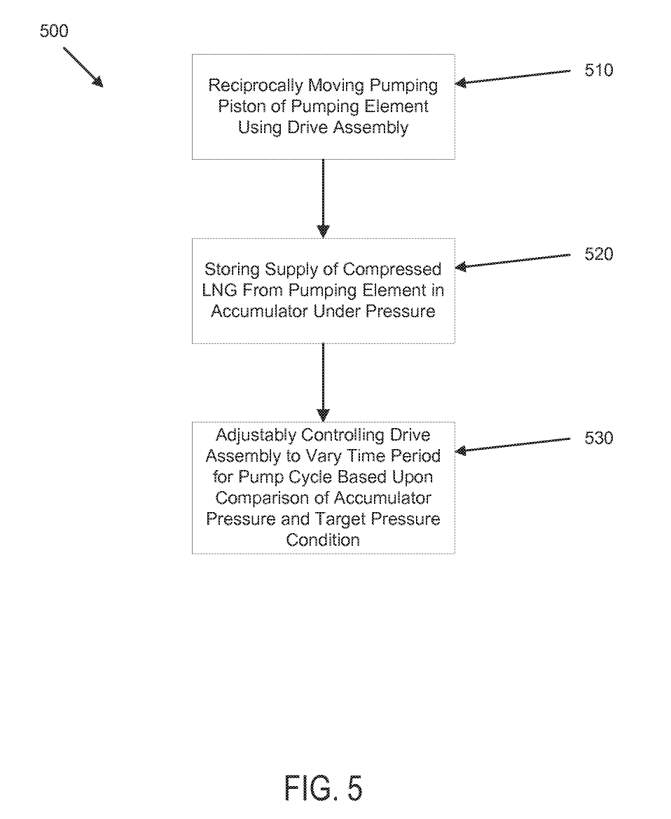

For example, referring to FIG. 5, steps of an embodiment of a method 500 for controlling a cryogenic pump system following principles of the present disclosure are shown in flowchart form. A pumping piston of a pumping element is reciprocally moved with a drive assembly over a pump cycle (step 510). The pump cycle includes an intake stroke and a power stroke, in opposing relationship to the intake stroke, to draw an amount of LNG from a cryogenic tank into a pumping chamber of the pumping element during the intake stroke and to compress the amount of LNG in the pumping chamber to form compressed LNG and pump the compressed LNG out of the pumping chamber during the power stroke, respectively. A supply of the compressed LNG from the pumping element is stored in an accumulator under pressure (step 520). The drive assembly is adjustably controlled to vary a time period for the pump cycle based upon a comparison of a pressure measured in the accumulator and a target pressure condition (step 530).

In embodiments, the drive assembly includes a hydraulic pump, which comprises a variable displacement pump in some embodiments. The pump system can be controlled by adjustably controlling the hydraulic pump to vary a flow of pressurized hydraulic fluid to vary an average pumping piston velocity based upon the comparison of the pressure measured in the accumulator and the target pressure condition.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A direct injection gas engine system, comprising:
an engine including at least one engine cylinder that forms a variable volume between a reciprocating piston, a bore, and a flame deck;
a liquid fuel system including a liquid fuel injector adapted to inject liquid fuel into the variable volume;
a gaseous fuel system including:
a cryogenic tank configured to contain a supply of liquefied natural gas (LNG),
a pumping element in fluid communication with the cryogenic tank, the pumping element having a pumping chamber and a pumping piston disposed therein, the pumping piston being reciprocally movable over a pump cycle having an intake stroke and a power stroke in opposing relationship to the intake stroke,
a drive assembly adapted to reciprocally move the pumping piston over the pump cycle to draw an amount of LNG from the cryogenic tank into the pumping chamber of the pumping element during the intake stroke and to compress the amount of LNG in the pumping chamber to form compressed LNG and pump the compressed LNG out of the pumping chamber during the power stroke,
an accumulator in fluid communication with the pumping element, the accumulator configured to contain under pressure a supply of the compressed LNG received from the pumping element,
a gaseous fuel injector in fluid communication with the pumping element and the accumulator, the gaseous fuel injector adapted to inject compressed LNG into the variable volume as a power source,
a pressure sensor operably arranged with the accumulator to detect an accumulator pressure within the accumulator and to emit an accumulator pressure signal indicative of the accumulator pressure, and
a controller in electrical communication with the drive assembly and the pressure sensor, the controller adapted to adjustably control the drive assembly to vary a time period for the pump cycle based upon a comparison of the accumulator pressure and a target pressure condition.

2. The direct injection gas engine system of claim 1, wherein the target pressure condition comprises a target pressure constant, and wherein the controller is adapted to adjustably control the drive assembly to increase the time period for the pump cycle if the accumulator pressure is greater than the target pressure constant and to reduce the time period for the pump cycle if the accumulator pressure is less than the target pressure constant.

3. The direct injection gas engine system of claim 1, wherein the controller is adapted to control the drive assembly such that when the accumulator pressure satisfies the target pressure condition, the controller is adapted to control the drive assembly such that the pumping element is in a creep mode in which the pumping element delivers no more than a nominal amount of compressed LNG to the accumulator within a predetermined tolerance and the time period for the pump cycle has a finite value.

4. The direct injection gas engine system of claim 3, wherein the target pressure condition comprises a target high pressure threshold and a target low pressure threshold, and wherein the controller is adapted to control the drive assembly such that the pumping element is in the creep mode once the accumulator pressure is greater than the target high pressure threshold and is maintained in the creep mode until the accumulator pressure is less than the target low pressure threshold.

5. The direct injection gas engine system of claim 4, wherein the controller is adapted to control the drive assembly such that, once the accumulator pressure falls below the target low pressure threshold, the pumping element is in a charge mode in which the pumping element delivers an amount of compressed LNG sufficient to increase the accumulator pressure to the target high pressure threshold.

6. The direct injection gas engine system of claim 1, wherein the controller is adapted to control the drive assembly such that when the accumulator pressure satisfies the target pressure condition, the controller is adapted to control the drive assembly such that the pumping element is in a creep mode in which the pumping piston has an average velocity greater than zero such that a frictional force imparted against the pumping piston comprises kinetic friction.

7. The direct injection gas engine system of claim 1, wherein the drive assembly includes a hydraulic pump in electrical communication with the controller, the hydraulic pump adapted to provide a source of pressurized hydraulic fluid with a variable flow for reciprocally moving the pumping piston, wherein the controller is adapted to adjustably control the hydraulic pump to vary a flow of pressurized hydraulic fluid to vary an average pumping piston velocity based upon the comparison of the accumulator pressure and the target pressure condition.

8. The direct injection gas engine system of claim 7, wherein the hydraulic pump comprises a variable displacement pump.

9. The direct injection gas engine system of claim 7, wherein the drive assembly comprises:
a hydraulic actuator in selective fluid communication with the source of pressurized hydraulic fluid, the hydraulic actuator operably arranged with the pumping piston of the pumping element to selectively reciprocally move the pumping piston, and
a directional control valve in electrical communication with the controller, the directional control valve in fluid communication with the source of pressurized hydraulic fluid and in selective fluid communication with the hydraulic actuator,
wherein the controller is adapted to selectively command the directional control valve to direct an intake flow of pressurized hydraulic fluid to the hydraulic actuator such that the hydraulic actuator moves the pumping piston of the pumping element over the intake stroke and a power flow of pressurized hydraulic fluid to the hydraulic actuator such that the hydraulic actuator moves the pumping piston over the power stroke.

10. The direct injection gas engine system of claim 9, wherein the hydraulic actuator comprises a cylinder and a hydraulic piston reciprocally movable within the cylinder over a range of travel between a retracted position and an extended position, the hydraulic piston including a piston head and a rod extending from the cylinder, the rod of the hydraulic actuator being operably arranged with the pumping piston of the pumping element such that moving the hydraulic piston of the hydraulic actuator moves the pumping piston of the pumping element.

11. The direct injection gas engine system of claim 1, wherein the liquid fuel system includes a liquid fuel pump configured to draw liquid fuel from a liquid fuel reservoir and provide liquid fuel compressed to a rail pressure to a liquid fuel rail that is fluidly connected to the liquid fuel injector.

12. The direct injection gas engine system of claim 1, wherein the gaseous fuel system further includes a heater interposed between, and in fluid communication with, the pumping element and the accumulator, the heater adapted to receive compressed LNG having a temperature from the pumping element and to increase the temperature of the compressed LNG to bring the compressed LNG to a supercritical gaseous state.

13. The direct injection gas engine system of claim 12, wherein the gaseous fuel system further includes a pressure control module interposed between, and in fluid communication with, the accumulator and the gaseous fuel injector, the pressure control module adapted to control a pressure of compressed LNG delivered to the gaseous fuel injector.

14. A gaseous fuel system comprising:
a cryogenic tank configured to contain a supply of liquefied natural gas (LNG);
a pumping element in fluid communication with the cryogenic tank, the pumping element having a pumping chamber and a pumping piston disposed therein, the pumping piston being reciprocally movable over a pump cycle having an intake stroke and a power stroke in opposing relationship to the intake stroke;
a drive assembly adapted to reciprocally move the pumping piston over the pump cycle to draw an amount of LNG from the cryogenic tank into the pumping chamber of the pumping element during the intake stroke and to compress the amount of LNG in the pumping chamber to form compressed LNG and pump the compressed LNG out of the pumping chamber during the power stroke;
an accumulator in fluid communication with the pumping element, the accumulator configured to contain under pressure a supply of the compressed LNG received from the pumping element;
a pressure sensor operably arranged with the accumulator to detect an accumulator pressure within the accumulator and to emit an accumulator pressure signal indicative of the accumulator pressure; and
a controller in electrical communication with the drive assembly and the pressure sensor, the controller adapted to adjustably control the drive assembly to vary a time period for the pump cycle based upon a comparison of the accumulator pressure and a target pressure condition such that the pumping piston continuously moves.

15. The gaseous fuel system of claim 14, wherein the target pressure condition comprises a target pressure constant, and wherein the controller is adapted to adjustably control the drive assembly to increase the time period for the pump cycle if the accumulator pressure is greater than the target pressure constant and to reduce the time period for the pump cycle if the accumulator pressure is less than the target pressure constant.

16. The gaseous fuel system of claim 14, wherein the controller is adapted to control the drive assembly such that when the accumulator pressure satisfies the target pressure condition, the controller is adapted to control the drive assembly such that the pumping element is in a creep mode in which the pumping element delivers no more than a nominal amount of compressed LNG to the accumulator within a predetermined tolerance and the time period for the pump cycle has a finite value.

17. The gaseous fuel system of claim 16, wherein the target pressure condition comprises a target high pressure threshold and a target low pressure threshold, and wherein the controller is adapted to control the drive assembly such that the pumping element is in the creep mode once the accumulator pressure is greater than the target high pressure threshold and is maintained in the creep mode until the accumulator pressure is less than the target low pressure threshold.

18. The gaseous fuel system of claim 17, wherein the controller is adapted to control the drive assembly such that, once the accumulator pressure falls below the target low pressure threshold, the pumping element is in a charge mode in which the pumping element delivers an amount of compressed LNG sufficient to increase the accumulator pressure to the target high pressure threshold.

19. A method for controlling a cryogenic pump system comprising:
reciprocally moving a pumping piston of a pumping element with a drive assembly over a pump cycle having an intake stroke and a power stroke, in opposing relationship to the intake stroke, to draw an amount of LNG from a cryogenic tank into a pumping chamber of the pumping element during the intake stroke and to compress the amount of LNG in the pumping chamber to form compressed LNG and pump the compressed LNG out of the pumping chamber during the power stroke, respectively;
storing in an accumulator under pressure a supply of the compressed LNG received from the pumping element;
adjustably controlling the drive assembly to vary a time period for the pump cycle based upon a comparison of a pressure measured in the accumulator and a target pressure condition.

20. The method for controlling a cryogenic pump system according to claim 19, wherein the drive assembly includes a hydraulic pump, and wherein adjustably controlling the drive assembly comprises adjustably controlling the hydraulic pump to vary a flow of pressurized hydraulic fluid to vary an average pumping piston velocity based upon the comparison of the pressure measured in the accumulator and the target pressure condition.
